(19) United States
(12) Patent Application Publication
(10) Pub. No.: US 2020/0027155 A1
(43) Pub. Date: Jan. 23, 2020

(54) Systems and Methods for Visualizing Garment Fit

(71) Applicant: Google LLC, Mountain View, CA (US)

(72) Inventors: David Frakes, Redwood City, CA (US); David Lo, Milpitas, CA (US); Eric Aboussouan, Campbell, CA (US); Mohamed Haitham Musa Babiker, Chandler, AZ (US); Karl Patrick Lawrence, Chandler, AZ (US); Roshanbir Bhatia, Tempe, AZ (US); Mark Nelson, Gilbert, AZ (US)

(21) Appl. No.: 16/487,648

(22) PCT Filed: Mar. 27, 2018
(86) PCT No.: PCT/US2018/024514

§ 371 Date: Aug. 21, 2019

Related U.S. Application Data
(60) Provisional application No. 62/478,264, filed on Mar. 29, 2017.

(51) Int. Cl. G06Q 30/06; G06N 20/00; G06T 19/20; G06T 17/20

(52) U.S. Cl. CPC G06Q 30/0643; G06N 20/00; G06T 19/20; G06T 2210/16; G06T 2219/2004; G06T 2219/2016; G06T 2219/2021; G06T 17/20

(57) ABSTRACT

Systems and methods for visualizing garment fit are provided. In one embodiment, the method can include obtaining garment data descriptive of a garment and body data descriptive of a body. The method can further include simulating a garment deformation of the garment due to contact from the body, and determining a simulating a body deformation of the body due to contact from the garment. The method can further include providing a visualization of the garment on the body for display to a user, the visualization visualizing the garment deformation and the body deformation.

PRIORITY CLAIM

The present application claims the benefit of priority of U.S. Provisional Patent Application No. 62/478,264 filed Mar. 29, 2017, entitled “Systems and Methods for Visualizing Garment Fit.” The above-referenced patent application is incorporated herein by reference.

### FIELD

The present disclosure relates generally to visualizing garment fit. More particularly, the present disclosure relates to computer systems and methods that improve the accuracy and efficiency of visualizing a garment fit on a body.

### BACKGROUND

With the growth of online shopping, there has been an increase in an amount of garments/apparel purchased online. However, when shopping online, unlike traditional brick and mortar stores, a purchaser cannot use a fitting room to try on the garment or otherwise physically interact with the garment. Thus, it can be challenging for an online shopper to gain a sense for how an item will fit on the shopper's body.

In particular, as an example challenge posed by online apparel shopping, apparel manufacturers do not adhere to national size standards and, in many cases, define their own. Consequently, online sizing labels can be ambiguous. Further, current sizing labels do not address body silhouette, which varies among the general population. Apparel manufacturers may design their sizing grades according to a specific body silhouette, which can also lead to ambiguity in the sizing label.

These challenges are especially problematic for highly structured garments such as pants, which have demanding fit requirements. To address the fit requirements for pants, apparel manufacturers commonly develop several different fashion styles with a greater number of sizes to fit the different body silhouettes. This solution can increase both costs for the manufacturer and the ambiguity of fit for the consumer.

As a result of the above described problems, an online shopper may purchase garments that, ultimately, are ill-fitting or otherwise do not conform to the shopper's expectations regarding fit. Thus, the shopper may feel dissatisfied with their purchase and/or seek to return the garment to the seller. As such, the online garment shopping industry typically suffers from significant rates of product return.

One possible solution to the above described problems is to acquire several body measurements from the consumer using a 3D body scanner, camera, or tape measure and then compare the measurements to the dimensions of the garment. Body measurements provide additional information to help alleviate the sizing challenge. However, body measurements do not address the consumer's subjective assessment of apparel fit or provide much information on style.

Another possible solution to the above described problems is the use of virtual fitting rooms. Using a virtual fitting room, a purchaser can visualize the fit and appearance of a garment on a body model. A purchaser can also create multiple body models of one or more body types, and visualize the fit and appearance of one or more garments on each body model and/or body type.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of visualizing garment fit. The method includes obtaining, by one or more computing devices, garment data descriptive of a garment and body data descriptive of a body. The method further includes simulating, by the one or more computing devices, a garment deformation of the garment due to contact from the body. The method further includes simulating, by the one or more computing devices, a body deformation of the body due to contact from the garment. The method further includes providing, by the one or more computing devices, a visualization of the garment on the body for display to a user. The visualization visualizes the garment deformation and the body deformation.

Another example aspect of the present disclosure is directed to a computing device for simulating a fit and appearance of a garment on a body. The computing device includes a modified finite element solver configured to simulate deformation of the garment on the body. The computing device includes a soft-body dynamics solver configured to simulate deformation of the body due to the garment.

Another example aspect of the present disclosure is directed to one or more tangible, non-transitory computer-readable media that collectively store instructions that, when executed by one or more computing devices, cause a computing system to perform operations. The operations include obtaining a garment model that models a garment and a body model that models a body. The operations include using a finite element solver to simulate deformation of the garment due to contact with the body model according to at least one of a body expansion approach, a body morphing approach, and a garment stitching approach. The operations include providing a visualization of the deformation of the garment model due to contact with the body model for display to a user.

Other example aspects of the present disclosure are directed to systems, apparatus, tangible non-transitory computer-readable media, user interfaces, memory devices, and electronic devices for visualizing garment fit.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which make reference to the appended figures, in which:

FIG. 1 depicts a block diagram of an example computing device in accordance with some implementations of the present disclosure;

FIG. 2 depicts a flow diagram of an example method for visualizing a fit and appearance of a garment on a body in accordance with some implementations of the present disclosure;

FIG. 3 depicts a flow diagram of an example method for simulating deformation of a garment using a body expansion approach in accordance with some implementations of the present disclosure;

FIG. 4 depicts a flow diagram of an example method for simulating deformation of a garment using a body morphing approach in accordance with some implementations of the present disclosure;

FIG. 5 depicts a flow diagram of an example method for simulating deformation of a body in accordance with some implementations of the present disclosure;

FIG. 6 depicts a flow diagram of an example method for preparing a garment model in accordance with some implementations of the present disclosure;

FIGS. 7(a) and 7(b) depict an example graphical diagram of a body-expansion approach in accordance with some implementations of the present disclosure;

FIGS. 8(a) and 8(b) depict an example graphical diagram of a body morphing approach in accordance with some implementations of the present disclosure; and

FIGS. 9 depicts an example graphical diagram of a garment stitching approach in accordance with some implementations of the present disclosure.

### DETAILED DESCRIPTION

Example aspects of the present disclosure are directed to systems and methods for visualizing a fit and appearance of any garment on a body. In some implementations, the systems and methods of the present disclosure can include or leverage high fidelity, coupled simulation solvers to accurately predict the fit and appearance of the garment relative to the body. In some implementations, a modified finite element solver can be used to simulate deformation of the garment due to contact from the body while a soft-body solver can be used to simulate deformation of the body due to contact from the garment. In one example application of the present disclosure, the systems and methods of the present disclosure can be employed to enable a user to virtually “try on” different garments before purchasing such garments. In particular, users (e.g., purchaser(s)) can visualize the style, texture, and sizing of different apparel on their body using the systems and methods of the present disclosure, thereby reducing the ambiguity of online apparel shopping, and leading to more informed purchases. In addition, users (e.g., designer(s), manufacturer(s)) can visualize the style, texture, and sizing of different apparel on a plurality of body models to aid in the design or manufacturing process.

According to aspects of the present disclosure, the systems and methods described herein can simulate garment fitting using a garment stitching approach. The garment stitching approach can be used in addition or alternatively to a garment morphing approach, a body expansion approach, and/or body morphing approach that will be discussed further below. In the garment stitching approach, computational models representing garment cutting patterns can be stitched directly on a three dimensional model (3D) of a body to create a 3D garment model representing the garment. Stitching can be performed by stitching different edges of a garment cutting pattern according to a specific sequence. The 3D garment model can be prepared to a specification of the simulation solvers. As an example, in some implementations, a garment pre-processor can generate or otherwise prepare a garment model for use in the garment fitting simulation.

In some implementations, the garment pre-processor can generate a model of a garment from one or more garment panels associated with such garment. For example, the one or more garment panels can be stored as a two-dimensional (2D) cutting pattern, a 2D mesh file, a 3D mesh file, or any other suitable format. One or more stitch lines/curves and one or more respective attachment points can be determined for each of the one or more garment panels. A finite element solver can be used to perform stitching by connecting the one or more stitch lines/curves in 3D along the one or more respective attachment points to create a 3D stitched garment. The finite element solver used to perform stitching can be the same as or different from the finite element solver used to perform garment deformation. The finite element solver can perform the stitching of the garment with or without a 3D body model between garment components.

In some implementations, a 3D garment model can be represented by or generated from or based on a computer-aided design (CAD) model file (e.g., .DXF file). The garment model file can include data representing a garment type and one or more garment panel(s). The garment type can correspond to a general classification of a garment, such as, for example, a shirt, pants, top, dress, etc. The garment panel(s) can correspond to cutting patterns for the garment. The garment panel(s) can be represented within the garment model file, for example, as blocks or pieces. Each of the garment panel(s) can also have or otherwise be associated with one or more garment feature(s). The garment feature(s) can include, for example, a dart, pocket, placket, j-curve, yolk, dart, embroidery, buttons, etc. The garment feature(s) can be represented within the garment model file, for example, as lines or patterns in one or more layers of each block or piece.

In some implementations, the garment pre-processor can generate or otherwise prepare a garment model based on an associated garment type. For example, the garment pre-processor can prepare a shirt garment model according to a pre-processing template that corresponds to shirt type garments. The garment pre-processor can include or obtain one or more pre-processing templates that correspond to one or more garment types. The garment pre-processor can select an appropriate pre-processing template for a garment model, based on an associated garment type of the garment model, and use the selected pre-processing template to prepare the garment model for garment simulation. The garment pre-processor can also automatically select the garment type and appropriate pre-processing template after identifying one or more garment panel(s) in a garment model file (e.g., CAD file, DXF) using pattern recognition.

In some implementations, a garment pre-processing template can provide a complete set of assembly instructions for an associated garment. The garment pre-processing template can be used while parsing a garment model file. The template can include instructions for positioning the associated garment; identifying stitch lines; and assembling one or more garment panel(s) on a 3D body model. The template can include a set of rules which use a two-dimensional position of the garment panel(s) and the 3D body model to define a transformation required to position the garment panel(s) around the 3D body model in a contract free state. The rules align the garment panel(s) so that the 3D body model has minimal interference with the garment as the garment panel(s) are stitched. The template can also use one or more boundary identifier(s) in the garment model file to define boundary pairs of garment panel(s) to be stitched during the assembly process. In addition, the template can include rules for handling optional design features in the garment model file (e.g., identified through automated feature recognition). The garment pre-processing template can include an orientation, order, and direction of assembly for the garment panel(s) so that the assembly around the 3D body model can be performed in a stable and efficient manner. The garment stitching can occur either sequentially between two garment panels (e.g., similar to manually stitching two pieces of cloth) or in a single step (e.g., fusing two pieces of cloth instantaneously). Multiple pairs of garment panels can also be fused concurrently.

In some implementations, the garment pre-processor can parse a garment model file (e.g., CAD file) to identify one or more garment panel(s), and classify each of the identified garment panel(s). The garment pre-processor can classify the identified garment panel(s) according to one or more body landmark(s). Each of the body landmark(s) can be associated with a specific region or location on a 3D body model. A body landmark can be associated with, for example, a front, back, chest, abdomen, seat, left/right arm, left/right leg, waist, neck, shoulders, left/right elbow, left/right knee, left/right wrist, etc. on a 3D body model. In some implementations, the garment model file can include data representing a body landmark classification for one or more garment panel(s), and the garment pre-processor classify the garment panel(s) based on the body landmark classification information. In some implementations, the garment pre-processor can classify the garment panel(s) based on a garment type and/or a garment panel shape.

As an example, if a garment model file includes a garment model of a shirt type garment, then the garment pre-processor can determine that the garment model file should include at least one garment panel for each of the body landmarks: chest and abdomen, back, left arm, right arm, and shoulders. If the garment model file includes a dress type garment, then the garment pre-processor can determine that the garment model file should include at least one garment panel for each of the body landmarks: front, and back. If the garment model file includes a pants type garment, then the garment pre-processor can determine that the garment model file should include at least one garment panel for each of the body landmarks: left leg, and right leg. Additionally, or alternatively, if the garment model file includes a pants type garment, then the garment pre-processor can determine that the garment model file should include at least one garment panel for each of the body landmarks: front (below the waist), and back (below the waist). These examples of panels expected to be found for each garment type are provided as examples only. A garment can include any number of different panels which have different associations.

As another example, the garment pre-processor can use a pattern recognition algorithm to classify each panel in the garment model file. For example, the garment pre-processor can use a pattern recognition algorithm to determine a body landmark classification for a garment panel. The garment pre-processor can obtain data indicative of a shape of a garment panel (e.g., from a garment model file), and input the data into the pattern recognition algorithm. The pattern recognition algorithm can output data indicative of a body landmark classification of the garment panel and/or data indicative of one or more geometric feature(s) of each garment panel. The pattern recognition algorithm can include, for example, a classification tree, a machine-learned pattern recognition model, and/or a probability/score calculation approach to help recognize the garment panel shape and/or the one or more geometric feature(s) of the garment panel, and to determine the body landmark classification of the garment panel. The machine learned approach and the probability/score calculation approach can use any unique identifying features of the garment panel to match it to a garment panel from a garment panel database. The pattern recognition algorithm can also use a combination of two or more garment panels from the garment model file to match to one garment panel in the garment panel database. The classification tree algorithm can use the output of the machine learned approach and/or probability/score calculation approach for each garment panel in the garment model file to identify the entire garment and/or a corresponding garment pre-processing template. The classification algorithm can use the probability/score match of the most unique garment panel (e.g., largest surface area, highest curvature) from the garment model file to identify the remaining garment panels required to complete the garment. For example, if the most unique garment panel that is best matched is the waist band, then the classification algorithm will try to complete identification of all garment pieces required to form a garment model (e.g., jeans or chinos) by searching for the remaining required panels such as the front panel, back panel, pocket facing, yoke, etc. The classification algorithm can also search for dependent panels (e.g., searching for possible coin pockets if a pocket facing is identified) using a hierarchical method. If the remaining required panels are not present to complete the identification of all garment pieces, then the pattern matching algorithm will use the second-best match for the most unique garment panel, which can be a collar. It will then try to identify the garment model as t-shirt/dress and then choose the appropriate garment pre-processing template based on the classified garment.

In some implementations, optionally subsequent to classifying the garment panel, the garment pre-processor can identify one or more garment feature(s) associated with a garment panel in a garment model file. For example, the garment pre-processor can use a probability lookup table, machine-learned feature recognition model, and/or other pattern recognition algorithms to identify the garment feature(s) based on lines or patterns in one or more layers of one or more blocks or pieces in the garment model file. The pattern recognition algorithm for identifying the one or more garment feature(s) can be similar to the pattern recognition algorithm to classify each panel in the garment model file described above.

In some implementations, the garment pre-processor can position the identified garment panel(s) on a 3D body model. The garment pre-processor can position the identified garment panel(s) based on the body landmark classification of the garment panel(s). The garment pre-processor can receive a 3D body model that includes one or more predetermined body landmark(s) associated with a predetermined region or location on the 3D body model. Alternatively, the garment pre-processor can obtain a template 3D body model that includes one or more predetermined body landmark(s) associated with a predetermined region or location on the 3D body model. The garment pre-processor can position and hold the garment panel(s) at a specific region or location on the 3D body model by matching the body landmark classification of the garment panel(s) with the predetermined body landmark(s) associated with the 3D body model, so that the garment panel(s) can be stitched to create a 3D garment model representing the garment. For example, if a garment panel is for a chest body landmark, then the garment pre-processor can position the garment panel at a region or location on a 3D body model that is associated with the chest body landmark (e.g., the chest region on the 3D body model).

In some implementations, the garment pre-processor can use a rules based approach to position the garment panel(s) on the 3D body model. In particular, the garment pre-processor can use the rules based approach (e.g., a garment pre-processing template) to fine-tune a location within a region on the 3D body model, and determine a segment or point within a garment panel that corresponds to the location. The garment pre-processor can position the segment or point within the garment panel at the location within the region on the 3D body model. The rules based approach can be based on a predetermined set of rules obtained from the garment pre-processing template.

As an example, if a garment panel is for a right arm body landmark, then the garment pre-processor can position a midpoint of the garment panel at an elbow location within a right arm region on the 3D body model. In addition, the garment pre-processor can position a should end of the garment panel at a shoulder location within the right arm region on the 3D body model. In addition, before positioning the midpoint, the garment pre-processor can determine if a length of the garment panel is sufficient for the garment panel to extend from the shoulder location to the elbow location.

As another example, if a garment panel is for a waist body landmark, then the garment pre-processor can determine how high or low to position the garment panel within the waist region on the 3D body model. The garment pre-processor can determine whether the garment panel and/or the garment model is associated with either the “low-rise” style or the “normal-rise” style (e.g., by parsing the garment model file). If so, then the garment pre-processor can position the garment panel at a predetermined location associated with the particular style. Alternatively, the garment pre-processor can analyze the garment panel to determine an appropriate rise height at which to positon the garment panel.

In some implementations, the garment pre-processor can determine an appropriate stitching sequence to stitch garment panel(s) to create a 3D garment model representing a garment. The stitching sequence can be based on, for example, a size, position, material properties, garment feature(s), etc. of the garment panel(s). The stitching sequence can include, for example, a stitching order and/or different stitching techniques for stitching the garment panel(s) along one or more stitch lines/curves and one or more attachment points for the garment panel(s). In some implementations, a rules based approach can be used to determine the stitching sequence. For example, a rule may specify that panels classified as a first type must be stitched prior to panels classified as a second type, and so forth according to rules that describe different priorities of panel types and combinations of panel types.

In some implementations, the garment pre-processor can create a 3D garment model representing a single size of a garment. For example, the garment pre-processor can determine an appropriate garment size that corresponds to a 3D body model used by the garment pre-processor to prepare the garment, and create a 3D garment model that represents the determined garment size. The 3D garment model can be morphed to represent a different size of the garment, or morphed to represent a different garment, when visualizing a fit and appearance of the garment, such as in a virtual fitting room, as will be discussed further below.

According to aspects of the present disclosure, the systems and methods described herein can include or otherwise leverage a garment materials database that stores information about various garments and/or their associated materials. As an example, the garment materials database can include one or more garment material models. As another example, the database can further contain textile mechanical properties (e.g., garment thickness, elasticity, bending stiffness, shear modulus in a warp and/or a weft direction, etc.) corresponding to each garment material model. In some implementations, the garment material properties can be identified or otherwise evaluated through mechanical testing. As such, a garment material model can be used in conjunction with the finite element solver to accurately simulate garment stitching. In some implementations, one or more textures corresponding to garment material models can be stored alongside the one or more garment material models in the garment materials database. In some implementations, in each virtual fitting simulation, a suitable garment material model is chosen based on the labelled material composition of the garment. In some implementations, a garment pre-processor can use the garment materials database to prepare a garment model for virtual fitting simulation. After stitching, corresponding textures can be mapped onto the 3D stitched garment.

According to aspects of the present disclosure, the systems and methods described herein can simulate garment fitting using a garment morphing approach. In the garment morphing approach, a 3D garment model representing a first size of a garment can be morphed to represent a different size of the garment, or morphed to represent a different garment. The 3D garment model can be morphed, for example, by changing an area of polygons associated with the 3D garment model, changing a 2D mesh representation that can be reflected in a 3D mesh representation of the 3D garment model, etc. The morphed 3D garment model can be used to simulate garment fitting. In this way, a plurality of variations of the garment can be simulated, when visualizing the fit and appearance of the garment, such as in a virtual fitting room, without the need to prepare (pre-process) a garment model for each of the variations.

As an example, a 3D garment model can represent a first size that corresponds to a 3D body model used by a garment pre-processor to prepare the 3D garment model. However, one or more different 3D body models can be used to visualize the fit and appearance of the garment during virtual fitting. In this case, an appropriate garment size can be determined for the different 3D body model, and the 3D garment model can be morphed to represent the determined size. Alternatively, a user can select a specific size of a garment for virtual fitting on a 3D body model, and/or granularly adjust a size of a 3D garment model until a specific size is found. The 3D garment model can be morphed to represent the specific size of the garment.

As another example, a user can virtually “try on” different garments within a particular garment type (e.g., shirt, pants, top, dress, etc.). In particular, the user can try a first garment that corresponds to a first garment type, and then try a second garment that corresponds to the first garment type. When the user tries the first garment, a previously prepared 3D garment model of the first garment (e.g., first garment model) can be used to simulate garment fitting. When the user tries the second garment, a previously prepared 3D garment model of the second garment (e.g., second garment model) can be used to simulate garment fitting. However, if the second garment model has not been previously prepared, or is not available, then the first garment model can be morphed to represent the second garment. Morphing the first garment model to represent the second garment can include, for example, stretching, shrinking, and smoothing the first garment model to mimic the dimensions of the second garment. Morphing the first garment model can also include, for example, adjusting a placement of garment features, a length of an inseam, adjusting a location at which to position garment panels of the first garment panel, adjusting garment material models being used to simulate the garment, etc.

According to aspects of the present disclosure, as a part of the virtual fitting simulation process, one or more body models can be prepared to a specification of the simulation solvers. Each body model can model a particular individual's body or a template body. As one example, in some implementations, a body pre-processor can generate or otherwise prepare a body model for use in the garment fitting simulation. In some implementations, a body model can be generated by discretizing a representation of a body into particles to create a particle-based representation of the body. Additionally or alternatively to the particle-based representation, the body model can be generated by discretizing a representation of a body into a surface mesh to create a mesh-based representation of the body. The particles or surface mesh can be spaced uniformly or spaced according to the curvature of the body (e.g., more particles in regions with high curvature).

In some implementations which employ the body expansion approach described below, the particles or surface mesh can then be compressed along one or more axes into a reduced volume to generate a spatially compressed 3D model of the body. For example, the particles or surface mesh can be compressed along respective axes towards a skeleton model that models a skeleton of the body. In another example, the particles or surface mesh can be compressed along respective axes towards a centroid of the body.

However, in some implementations which employ the body morphing approach described below, the particle-based or mesh-based representation of the body is not compressed, and is instead morphed to a target body. Further, in some implementations, the particle-based or mesh-based representation of the body is compressed and then morphed to a target body before, during, and/or after expansion.

According to aspects of the present disclosure, in addition or alternatively to a particle-based or mesh-based representation of a body, a body model can be generated by discretizing a representation of the body into a multi-layered tetrahedron mesh to create a volume-based representation of the body. Each layer in the multi-layered mesh can correspond to one or more body materials (e.g., adipose tissue, muscle, bone, etc.). A thickness of each layer can correspond to a distribution of each body material in the body.

As will be discussed further below, in some implementations, the particle-based or mesh-based body model can be used to simulate deformation of the garment due to contact from the body while the volume-based body model can be used to simulate deformation of the body due to the garment.

According to aspects of the present disclosure, the systems and methods described herein can simulate garment fitting using a body expansion approach. In the body expansion approach, a 3D model of a body can be spatially compressed. The body model can be a representation of a target body (e.g., a target individual's body, a target population's mean body, an avatar, etc.) or a template body. The template body can be based on, for example, a mean body of a specific population or a common body or silhouette. In some implementations, the body model can be compressed toward a skeleton model that models a skeleton of the body or can be compressed towards a centroid of the body. Following spatial compression, the body model can be expanded to its original form or another form while positioned within a garment model that models a garment. As the spatially compressed 3D body model is expanded, a finite element solver can be used to simulate deformation of the garment due to contact with the body. In particular, in some implementations, the garment can be stitched onto the compressed body model using the garment stitching approach described above. Following such garment stitching, the compressed body model can be expanded to its original size. In some implementations, a ray-casting algorithm can be used to virtually expand the spatially compressed 3D body model. Furthermore, in some implementations, the finite element solver can be coupled with a soft-body dynamics solver to additionally simulate deformation of the 3D body model due to contact with the garment model, as will be discussed further below.

According to aspects of the present disclosure, the systems and methods described herein can simulate garment fitting using a body morphing approach. In the body morphing approach, a 3D model of a template body can be morphed to display one or more specific features of a target body (e.g., a target individual's body, a target population's mean body, an avatar, etc.). The body model of the template body can morph to a target body while positioned within a garment model that models a garment. As the body model is morphed, a finite element solver can be used to simulate deformation of the garment due to contact with the body. In particular, in some implementations, the garment can be stitched onto the template body model using the garment stitching approach described above. Following such garment stitching, the templated body model can be morphed to the target body model. In some implementations, the finite element solver can also be coupled with a soft-body dynamics solver to simulate deformation of the 3D model representing the body, as will be discussed further below.

According to aspects of the present disclosure, a finite element solver can be used to simulate deformation of a garment. For example, in-plane and out-of-plane stiffness can be decoupled in the finite element solver to mimic cloth behavior. In another example, co-rotational elements can be used to permit large garment deformation. In another example, an isometric bending model can be used to efficiently capture garment folding. In another example, an adaptive re-meshing algorithm can be used to modify a garment mesh by refining regions of the mesh with high curvature and coarsening regions with low curvature. In another example, a semi-implicit Euler method can be used to perform time integration and solve motion equations. In another example, contact between a garment and a body can be detected using a ray-casting algorithm. In another example, an edge-to-edge and node-to-face detection algorithm can be used to detect garment self-collisions or contact between the garment and a body. In another example, a bounding volume hierarchy algorithm and parallel implementation can be used to improve the efficiency of contact detection. In yet another example, an impulse-based algorithm together with continuous collision detection can be used to ensure that there are no self-intersections during simulation.

According to aspects of the present disclosure, a soft-body dynamics solver can be used to simulate deformation of a body due to a garment pressure. In some implementations, the soft-body dynamics solver can be implemented with a finite element solver. In other implementations, the soft-body dynamics solver can be implemented with a mass-spring (MS) solver and a tetrahedron mesh representing a volume-based representation of a body. One or more tetrahedral nodes of the tetrahedron mesh can be represented by one or more particles with a respective mass, and one or more tetrahedral edges of the tetrahedron mesh can be represented by one or more springs with a respective stiffness value. In some implementations, the tetrahedron mesh can be a multi-layered tetrahedron mesh with each layer corresponding to one or more body materials. A stiffness value of a spring can be based on a body material of the layer corresponding to the tetrahedral edge the spring represents. In some implementations, global and local volume preservation constraints can be implemented to realistically simulate a deformation of a body. In some implementations, a soft-body dynamics solver can be coupled with a finite element solver to ensure that a pressure imposed by a garment and a stiffness of a body reach equilibrium.

Thus, in some implementations, the systems of the present disclosure can include some or all of the following components or sub-systems: a garment materials database that stores a corpus of material properties or models that have been developed, for example, through textile mechanical testing; a garment pre-processor that generates a garment model; a body pre-processor that generates a body model; a finite element solver (e.g., a modified fast finite element solver); and/or a soft-body dynamics solver.

In some implementations, virtual garment fitting can be implemented using a mass-spring simulation solver and a position-based simulation solver. In some implementations, virtual garment fitting can be implemented using a finite element simulation solver with the garment stitching approach. In some implementations, virtual garment fitting can be implemented using a finite element solver with an explicit solver, instead of a semi-implicit solver. In some implementations, virtual garment fitting can be implemented using a shape-based approach. In the shape-based approach, an energy minimization algorithm can be used to deform a garment to a body's contours. In some implementations, a body-expansion approach can be simulated using a discrete element algorithm, instead of a ray-casting algorithm. In some implementations, a soft-body dynamics solver can be implemented using a finite element simulation, instead of a mass-spring simulation. In some implementations, virtual garment fitting can be implemented using an avatar that approximates a body.

According to aspects of the present disclosure, virtual garment fitting can be implemented using sub-space modeling, pattern recognition, and/or machine learning to improve simulation efficiency. A large training set of high fidelity simulations can be used to inform new virtual try-on simulations, thereby improving the efficiency of the simulation.

The systems and methods described herein can provide a number of technical effects and benefits. For instance, the disclosed techniques provide improved accuracy in visualizing a fit and appearance of a garment. More particularly, the systems and methods of the present disclosure contrast with an alternative approach to visualizing garment fit in which the garment is “draped” onto a rigid body model. In particular, in this alternative garment draping approach, a mass-spring or position-based simulation solver can be used to model the deformation of the garment during virtual fitting.

However, this alternative garment draping approach suffers from several shortcomings. First, mass-spring/position-based solvers are notoriously inaccurate and require user-defined calibration for achieving visually plausible results. Second, mass-spring/position-based solvers are incapable of directly using mechanical material properties, which further reduces their accuracy for simulating garment deformation. Third, mass-spring/position-based solvers are highly dependent on the discretization of the garment and body model. As such, increasing the spatial resolution of a garment can lead to different results in a mass-spring/position-based solver. Fourth, the garment draping approach is inefficient because the entire stitching process, from start to finish, needs to be simulated for each unique case. Fifth, the garment draping approach is non-robust. Multiple stitching sequences may be tested for each consumer body because the stitching sequence can be dependent on the body type and garment style. Sixth, the use of a rigid body in a virtual try-on simulation does not address the body shape conforming feature of, for example, tight-fitting jeans, which suffer from high return rates. Therefore, changes to the body silhouette because of tight fitting clothing are not captured by conventional mass-spring/position-based approaches with rigid bodies.

Thus, in at least some implementations of the present disclosure, in contrast to the alternative draping approach described above, the computer simulation systems described herein can use a finite element solver rather than a mass-spring/position-based, thereby resolving many of the issues described above. In particular, as a spatially compressed body model is expanded within a garment model and/or a template body model is morphed within the garment model, a finite element solver can be used to simulate deformation of the garment due to contact with the body. In addition, the finite element solver can be coupled with a soft-body solver that simulates deformation of the body due to contact from the garment.

As one example technical effect and benefit of the present disclosure, in contrast to the mass-spring/position-based garment draping approach, the disclosed techniques produce simulation results at engineering level accuracy. Additionally, by using mechanical properties of a garment and body, the techniques disclosed herein yield a much greater level of accuracy than position-based/mass-spring solvers. Furthermore, the disclosed techniques capture the shape conforming behavior of tight fitting clothing by deforming the body according to garment pressure.

Another example technical effect and benefit of the present disclosure is improved efficiency. The garment stitching approach can handle garment stitching offline, thereby improving the efficiency of the virtual garment fitting simulation, and the garment morphing approach is more robust than the garment draping approach since it does not require determination of a stitching sequence for each simulation. In particular, a garment model can be prepared such that it can be morphed to represent different sizes of a garment, or even a different garment. In this way, a single 3D garment model can be created which can be morphed as needed. Therefore, resources that would be expended on generating every available size, or every available garment, can be saved.

Another example technical effect and benefit of the present disclosure is increasing the efficiency of package shipping, routing, and delivery systems. In particular, allowing a customer to virtually “try on” different apparel before purchasing can reduce the high return rates associated with online apparel shopping. Therefore, the number of packages that correspond to returned garments can be reduced, thereby improving the efficiency of package delivery systems and reducing waste generated by such systems.

The systems and methods described herein can also provide a technical effect and benefit of improved computer technology. More particularly, by improving the accuracy and efficiency of visualizing a fit and appearance of a garment on a body, computing devices can focus computational resources on other tasks such as receiving and placing orders for the garment, or visualizing a fit and appearance of another garment on the body. This can enhance computing system performance and processing speed since such use of resources can allow the computing devices to provide a more efficient, reliable, and accurate response to an event.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

With reference now to the FIGS., example embodiments of the present disclosure will be discussed in further detail.

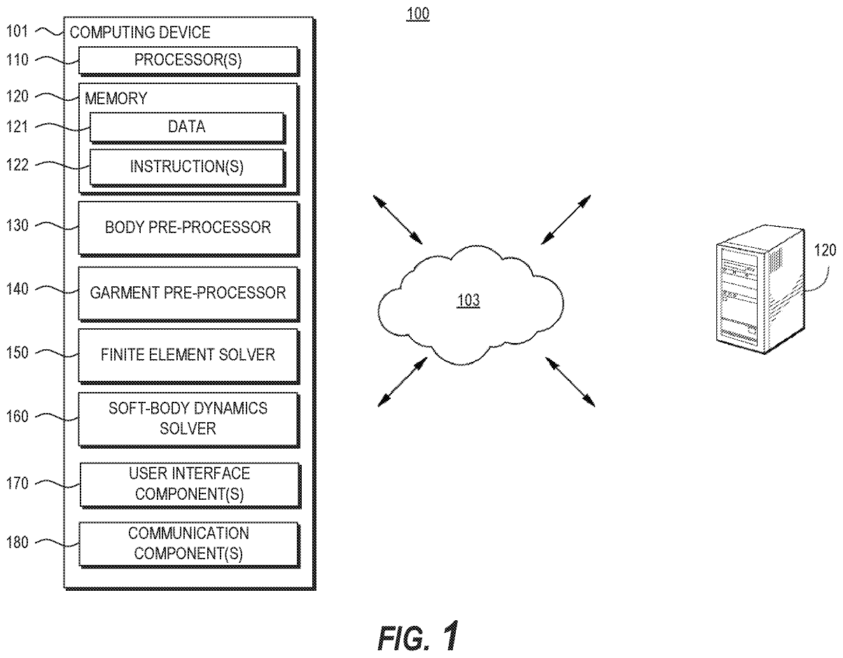

FIG. 1 depicts an example system 100 including computing device 101 for visualizing a garment fit according to example embodiments of the present disclosure. The computing device 101 can include at least one of: processor(s) 110, memory 120, body pre-processor 130, garment pre-processor 140, finite element solver 150, soft-body dynamics solver 160, user interface component(s) 170, and communication component(s) 180. The computing device 101 can communicate with one or more computing devices 102 that are remote from the computing device 101, via the network 103.

The one or more processors 110 can be any suitable processing device (e.g., a processor core, a microprocessor, an ASIC, a FPGA, a controller, a microcontroller, etc.) and can be one processor or a plurality of processors that are operatively connected. The memory 120 can include one or more non-transitory computer-readable storage mediums, such as RAM, ROM, EEPROM, EPROM, flash memory devices, magnetic disks, etc., and combinations thereof.

The memory 120 can store data 121 and instructions 122 which are executed by the processor 110 to cause computing device 101 to perform operations. In particular, in some implementations, the data 121 can include at least one of: a garment materials database, and one or more garment panels. The garment materials database can include at least one of: one or more garment material models, one or more textile mechanical properties corresponding to each garment material model (e.g., garment thickness, elasticity, bending stiffness, shear modulus in a warp and/or a weft direction, etc.), and one or more textures corresponding to each garment material model. In some implementations, the data 121 can include one or more garment material model files. In addition, in some implementations, the data 121 can include pre-processed template body models and/or pre-processed garment models, as will be described further below.

The body pre-processor 130 can be configured to prepare a body model of a body to one or more specifications of one or more simulation solvers (e.g., finite element solver 150, soft-body dynamics solver 160, etc.). The body pre-processor 130 can prepare the body model by discretizing a representation of the body. In some implementations, the body pre-processor 130 can discretize the body to create a particle-based and/or mesh-based representation of the body (e.g., a particle-based or mesh-based body model) or a volume-based representation of the body (e.g., a volume-based body model).For example, the body pre-processor 130 can create the particle-based body model by uniformly spacing the one or more particles or by spacing the one or more particles according to a curvature of the body (e.g. more particles in regions with high curvature). As another example, the body pre-processor 130 can create the mesh-based body model by uniformly spacing one or more mesh nodes or by spacing the one or more mesh nodes according to a curvature of the body (e.g., more mesh nodes in regions with high curvature). In some implementations, the body pre-processor 130 can compress a particle-based or mesh-based body model along one or more axes into a reduced volume to create a spatially compressed representation of the body (e.g., a spatially compressed body model). For example, the body pre-processor 130 can compress the particle-based body model toward a skeleton model that models a skeleton of the body to create the spatially compressed body model. In another example, the particles can be compressed along respective axes towards a centroid of the body.

In some implementations, the body pre-processor 130 can skip compression. For example, the body pre-processor 130 can select a body model representing a template body (e.g., for use by a body morphing approach), or select a body model representing a target body (e.g., for use by a garment stitching approach).

In some implementations, the body pre-processor 130 can discretize the body into one or more layers to create a volume-based representation of the body. The volume-based representation can be, for example, a multi-layered tetrahedron mesh. Each layer of the multi-layered tetrahedron mesh can correspond to one or more body materials of the body (e.g., fat, muscle, bone, etc.), and each layer can be associated with one or more thickness values that correspond to a distribution of the one or more body materials in the body.

The garment pre-processor 140 can be configured to prepare a garment model of a garment to one or more specifications of one or more simulation solvers (e.g., finite element solver 150, soft-body dynamics solver 160, etc.). In some implementations, the garment pre-processor 140 can prepare the garment model by stitching one or more garment panels along one or more stitch lines or curves. For example, the garment pre-processor 140 can generate a garment model of a garment based at least in part on one or more garment panels associated with the garment. The garment pre-processor 140 can obtain the one or more garment panels from the memory 120. The garment pre-processor 140 can determine one or more stitch lines/curves and one or more respective attachment points for each of the one or more garment panels. In some implementations, a finite element solver can be used to perform stitching by connecting the one or more stitch lines/curves in 3D along the one or more respective attachment points to create a 3D stitched garment. The finite element solver can be used to perform stitching can be the finite element solver 150 or a different finite element solver. The finite element solver can perform the stitching of the garment with or without a body model between garment components. For example, the garment pre-processor 140 can perform the stitching without a body model, so that a body expansion approach can expand a spatially compressed body model (e.g., representing a target body or template body), inside the garment model. As another example, the garment pre-processor 140 can perform the stitching without a body model, so that a body morphing approach can morph a body model (e.g., representing a template body) to a target body, inside the garment model. As yet another example, the garment pre-processor 140 can perform the stitching with a body model, so that a garment stitching approach can stitch garment cutting patterns directly on the body model. After stitching, the garment pre-processor 140 can map corresponding textures onto the one or more garment panels of the stitched garment based on a garment material model corresponding to each of the garment panels.

The finite element solver 150 can be configured to simulate deformation of a garment on a body. The finite element solver 150 can be, for example, a modified finite element solver. The finite element solver 150 can obtain a spatially compressed or uncompressed body model from the body pre-processor 130, and a garment model of the garment from the garment pre-processor 140. In some implementations, the finite element solver 150 can expand a spatially compressed body model to its original size, inside the garment model. In some implementations, the finite element solver 150 can morph a body model representing a template body to a target body, inside the garment model. In some implementations, the finite element solver 150 can expand a spatially compressed body model representing a template body, and morph the body model to a target body. In some implementations, the finite element solver 150 can use a ray-casting algorithm to expand the spatially compressed body model. As a body model is expanded and/or morphed, the finite element solver 150 can simulate a deformation of the garment model based at least in part due to contact with the body model and/or one or more textile mechanical properties of the garment model. In some implementations, the finite element solver 150 can be coupled with the soft-body dynamics solver 160, discussed below.

The soft-body dynamics solver 160 can be configured to simulate deformation of a body due to a garment. In some implementations, the soft-body solver operates or is implemented after the body model is expanded and/or morphed by the finite element solver 150. However, in other implementations, the soft-body solver can be used from the start of the simulation (e.g., during the expansion and/or morphing of the body model).

In particular, in some implementations, the soft-body dynamics solver 160 can obtain a spatially compressed body model (e.g., representing a target body or a template body) or an uncompressed body model (e.g., representing a target body or a template body) from the body pre-processor 130, and a garment model of the garment from the garment pre-processor 140. In some implementations, the soft-body dynamics solver 160 can expand a spatially compressed body model to its original size inside the garment model and determine a garment pressure on the expanded body model. In some implementations, the soft-body dynamics solver 160 can morph a body model to a target body inside the garment model and determine a garment pressure on the morphed body model. In some implementations, the soft-body dynamics solver 160 can both expand a body model to its original size and morph the body model to a target body inside the garment model, and determine a garment pressure on the expanded and morphed body model.

As an example, the soft-body dynamics solver 160 can be implemented with a mass-spring solver and a volume-based body model (e.g. obtained via the body pre-processor 140). The volume-based body model can be a tetrahedron mesh with one or more tetrahedral nodes of the tetrahedron mesh represented by one or more particles with a respective mass, and one or more tetrahedral edges of the tetrahedron mesh represented by one or more springs with a respective stiffness value. Each respective stiffness value can be based at least in part on a body material associated with a tetrahedral edge the spring represents. In some implementations, the soft-body dynamics solver 160 can implement global and/or local volume preservation constraints to realistically simulate deformation of the body. In some implementations, the soft-body dynamics solver can be coupled with the finite element solver 150 to ensure that a pressure imposed by the garment and a stiffness of the body reach equilibrium.

The user interface component(s) 170 can include various input and/or output component(s) for providing and receiving information from a user. For example, the user interface component(s) 170 can include a touch screen, touch pad, data entry keys, speakers, and/or a microphone suitable for voice recognition. The user interface component(s) 170 can also include one or more display devices for displaying a visualization of garment fit.

The communications component(s) 180 can include one or more components to communicate with one or more other components of system 100 (e.g., computing device(s) 102) over the network 103. The communications component(s) 180 can include any suitable components for interfacing with one more networks, including for example, transmitters, receivers, ports, controllers, antennas, or other suitable components.

The network 103 can be any type of communications network, such as a local area network (e.g. intranet), wide area network (e.g. Internet), cellular network, or some combination thereof. The network 103 can also include a direct connection between the computing device 101 and the computing device(s) 102. In general, communication between computing device 101 and computing device(s) 102 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

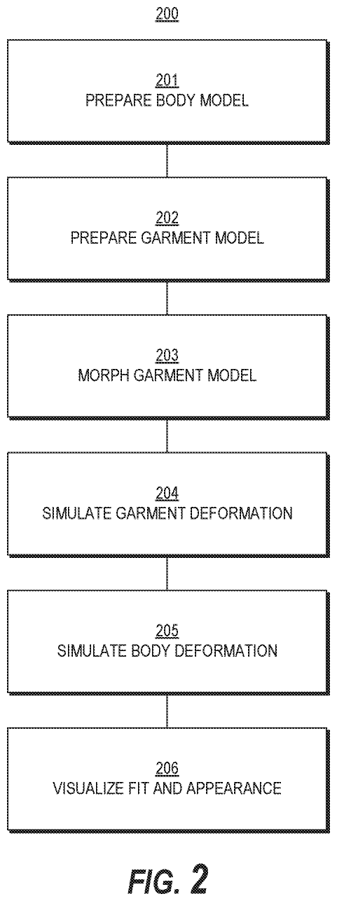

FIGS. 2-4 depict flow diagrams of example method(s) of visualizing garment fit according to example embodiments of the present disclosure. The method(s) can be implemented by one or more computing devices, such as the computing device 101 depicted in FIG. 1. Moreover, one or more portions of the method(s) can be implemented as an algorithm on the hardware components of the device(s) described herein (e.g., as in FIG. 1) to, for example, visualize garment fit. FIGS. 2-4 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

FIG. 2 depicts a flow diagram of an example method 200 for visualizing garment fit, according to example embodiments of the present disclosure.

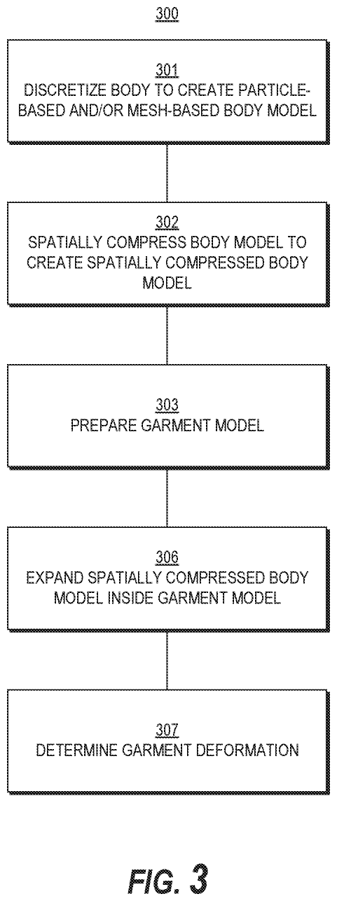

At (201), the method 200 can include preparing a body model of a body. For example, the body pre-processor 130 can prepare the body model of the body by discretizing a body into particles or a surface mesh to create a particle-based body model or mesh-based body model, discretizing each of one or more template bodies into particles or surface-mesh to create a particle-based or mesh-based template body model, or discretizing a body into layers to create a volume-based body model, as will be described below with respect to FIG. 3, 4, or 5, respectively.

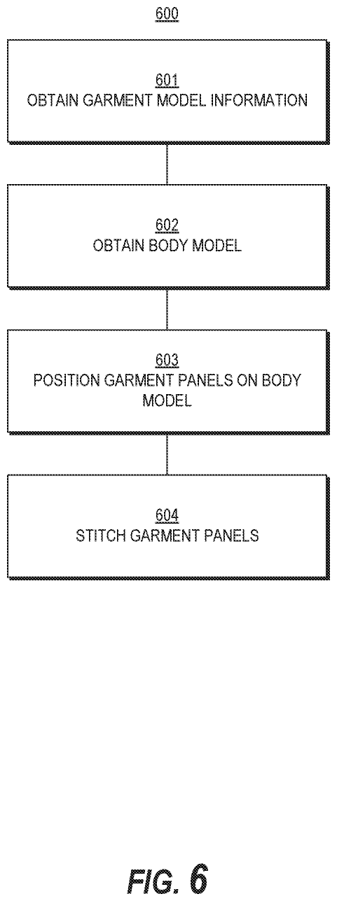

At (202), the method 200 can include preparing a garment model of a garment. For example, the garment pre-processor 140 can prepare the garment model of the garment, as will be described below with respect to FIG. 6.

At (203), the method 200 can include morphing the garment model. For example, the garment model can be morphed to represent a different size of the garment, or to represent a different garment.

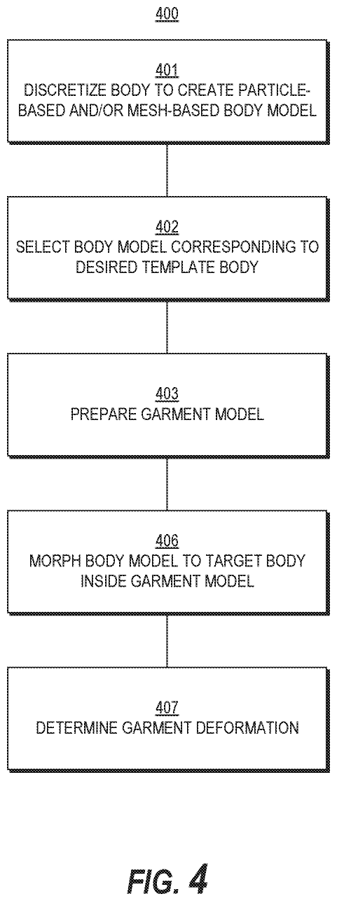

At (204), the method 200 can include simulating garment deformation. For example, the finite element solver 150 can simulate garment deformation, as described below with respect to FIG. 3 or 4.

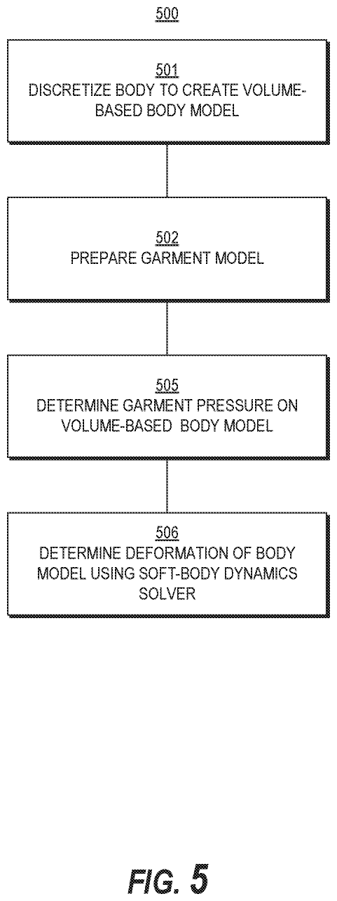

At (205), the method 200 can include simulating body deformation. For example, the soft-body dynamics solver 160 can simulate body deformation, as described below with respect to FIG. 5.

At (206), the method 200 can include visualizing garment fit and appearance. Visualizing garment fit and appearance can include, for example, providing data indicative of garment fit and appearance to a component among the user interface component(s) 170, such as a display. As another example, visualizing garment fit at 205 can include transmitting or otherwise providing over network 103 data that enables a remote computing device 102 to display a visualization of the garment fit and appearance.

FIG. 3 depicts a flow diagram of an example method 300 for simulating garment deformation using a body-expansion approach, according to example embodiments of the present disclosure. In the body expansion approach, a spatially compressed body model is expanded inside a garment model to simulate deformation of the garment model due to contact with the body.

At (301), the method 300 can include discretizing a body into particles or a surface mesh to create a particle-based body model or mesh-based body model. For example, the body pre-processor 130 can create the particle-based or mesh-based body model by discretizing a representation of a body into one or more particles or mesh nodes, respectively.

At (302), the method 300 can include spatially compressing the particle-based body model or the mesh-based body model to create a spatially compressed body model. For example, the body pre-processor 130 can create the spatially compressed body model by compressing a particle-based or mesh-based representation of a body.

At (303), the method 300 can include preparing a garment model of a garment. For example, the garment pre-processor 140 can prepare the garment model of the garment, as will be described below with respect to FIG. 6.

At (306), the method 300 can include expanding the spatially compressed body model inside the garment model. For example, the finite element solver 150 can expand the spatially compressed body model inside the garment model.

At (307), the method 300 can include simulating garment deformation. For example, as the spatially compressed body model is expanded, the finite element solver 150 can determine a deformation of the garment model based at least in part due to contact with the body model and/or one or more textile mechanical properties of the garment model.

FIG. 4 depicts a flow diagram of an example method 400 for simulating garment deformation using a body morphing approach, according to example embodiments of the present disclosure. In the body-morphing approach, a template body model representing a template body is morphed to a target body while inside a garment model to simulate the deformation of the garment due to contact with the body.

At (401), the method 400 can include discretizing each of one or more template bodies into particles or surface-mesh to create a particle-based or mesh-based template body model, respectively, for each of the one or more template bodies, thereby generating one or more reusable template body models. For example, the body pre-processor 130 can create the particle-based or mesh-based template body model by discretizing a representation of each of the one or more template bodies into one or more particles or mesh nodes. Thus, as a result, one or more particle-based or mesh-based template body models can be generated based on one or more template bodies which may represent one or more different body types (e.g., tall male versus petite female).

In some implementations, block (401) is performed only once and the resulting template body models can be stored for later use. Thus, subsequent instances of method 400 can simply include accessing a previously generated template body model from memory.

At (402), the method 400 can select a template body model that corresponds to a desired template body. For example, the method 400 can select a template body model that represents an average body size of a population, a common body silhouette or type, etc. In some implementations, the template body model that corresponds to a template body that is closest to a target body can be selected.

At (403), the method 400 can include preparing a garment model of a garment. For example, the garment pre-processor 140 can prepare the garment model of the garment, as will be described below with respect to FIG. 6.

In some implementations, rather than perform block (403) at each instance of method 400, one or more previously stitched garment models can be accessed from memory. For example, a garment model for each of the one or more template body models can be obtained by stitching the garment onto each of the one or more template body models. The resulting garment models can be stored in memory. Thereafter, the garment model that corresponds to the template body model that was selected at (402) can simply be accessed from memory.

At (406), the method 400 can include morphing the template body model inside a garment model. For example, the finite element solver 150 can morph the template body model to a target body inside the garment model.

At (407), the method 400 can include simulating garment deformation. For example, as the template body model is morphed, the finite element solver 150 can determine a deformation of the garment model based at least in part due to contact with the body model and/or one or more textile mechanical properties of the garment model.

FIG. 5 depicts a flow diagram of an example method for simulating deformation of a body, according to example embodiments of the present disclosure.

At (501), the method 500 can include discretizing a body into layers to create a volume-based body model. For example, the garment pre-processor 140 can create the volume-based body model by discretizing a representation of a body into one or more layers.

At (502), the method 500 can include preparing a garment model of a garment. For example, the garment pre-processor 140 can prepare the garment model of the garment, as will be described below with respect to FIG. 6.

At (505), the method 500 can include determining garment pressure on the volume-based body model. For example, in some implementations, the soft-body dynamics solver 160 can determine garment pressure based at least in part on garment deformation determined by the finite element solver 150.

At (506), the method 500 can include determining a deformation of the body model due to the pressure on the volume-based body model. For example, the soft-body dynamics solver 160 can determine body deformation based at least in part on the garment pressure on the volume-based body model prepared by the body pre-processor 130.

In one example, the volume-based body model can be a tetrahedron mesh and the soft-body dynamics solver can use a mass-spring solver to simulate body deformation. In particular, one or more tetrahedral nodes of the tetrahedron mesh can be represented by one or more particles with a respective mass, and one or more tetrahedral edges of the tetrahedron mesh can be represented by one or more springs with a respective stiffness value. In some implementations, the tetrahedron mesh can be a multi-layered tetrahedron mesh with each layer corresponding to one or more body materials. A stiffness value of a spring can be based on a body material of the layer corresponding to the tetrahedral edge the spring represents. In addition, in some implementations, global and local volume preservation constraints can be implemented to realistically simulate a deformation of a body.

FIG. 6 depicts a flow diagram of an example method 600 for preparing a garment model of a garment.

At (601), the method 600 can include obtaining data indicative of a garment model. The data indicative of the garment model can include, for example, garment panels, garment features, and garment material properties. As an example, memory 120 can include one or more garment panels and a garment materials database. The one or more garment panels can include one or more garment features associated with the garment panels. The garment materials database can include one or more garment material models, one or more textile mechanical properties corresponding to each garment material model, and one or more textures corresponding to each garment material model. The garment pre-processor 140 can obtain the one or more garment panels, and one or more associated garment features from the memory 120, and obtain garment material properties corresponding to the garment panels from the garment materials database in the memory 120.

At (602), the method 600 can include obtaining data indicative of a body model. For example, the memory 120 can include pre-processed template body models, and the garment pre-processor 140 can select one of the pre-processed template body models. The selected body model can include one or more predetermined body landmarks associated with a predetermined region or location on the body model.

At (603), the method 600 can include positioning the garment panels onto the body model. For example, the garment pre-processor 140 can classify each of the garment panels according to one or more body landmarks, and match the garment panels with the one or more predetermined body landmarks associated with the body model, in order to position the garment panels on the body model. In addition, the garment pre-processor 140 can use a rules based approach to fine-tune a location at which to position the garment panels on the body model.

At (604), the method 600 can include stitching the garment panels to prepare the garment model. For example, the garment pre-processor 140 can analyze the garment panels, and determine a stitching sequence based on a size, position, material properties, or garment features associated with the garment panels. The stitching sequence can include, for example, a stitching order and/or different stitching techniques for stitching the garment panels along one or more stitch lines/curves and one or more attachment points. The garment pre-processor 140 can stitch each of the garment panels along the one or more stitch lines/curves and one or more respective attachment points.

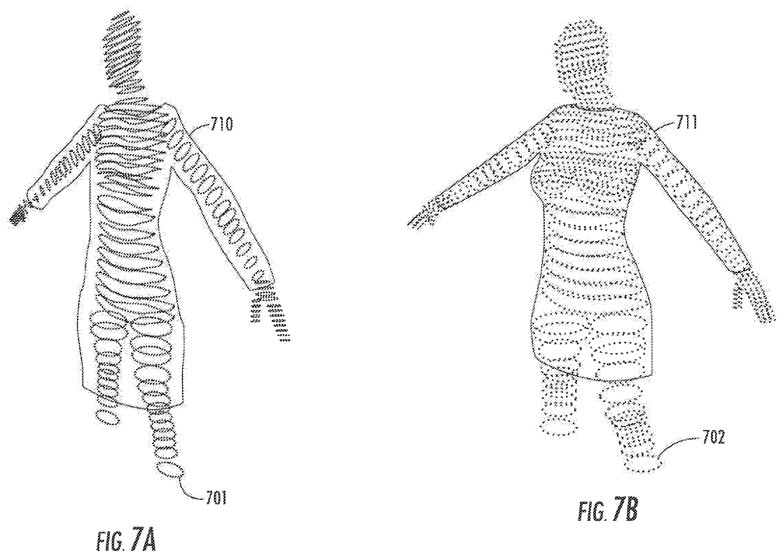

FIGS. 7(a) and 7(b) depict an example graphical diagram of a body-expansion approach to visualize garment deformation, according to example embodiments of the present disclosure. FIG. 7(a) depicts a spatially compressed body model 701 inside a garment model 710. The spatially compressed body model 701 and the garment model 710 can be prepared, for example, by the body pre-processor 130 and the garment pre-processor 140, respectively. The spatially compressed body model 701 is expanded inside the garment model 710, for example, by the finite element solver 150. FIG. 7(b) depicts an expanded body model 702 (e.g., the spatially compressed body model 701 after being expanded to its original form), and a deformed garment model 711. For example, the finite element solver 150 can determine garment deformation based at least in part on the expansion of the spatially compressed body model 701 to the expanded body model 702.

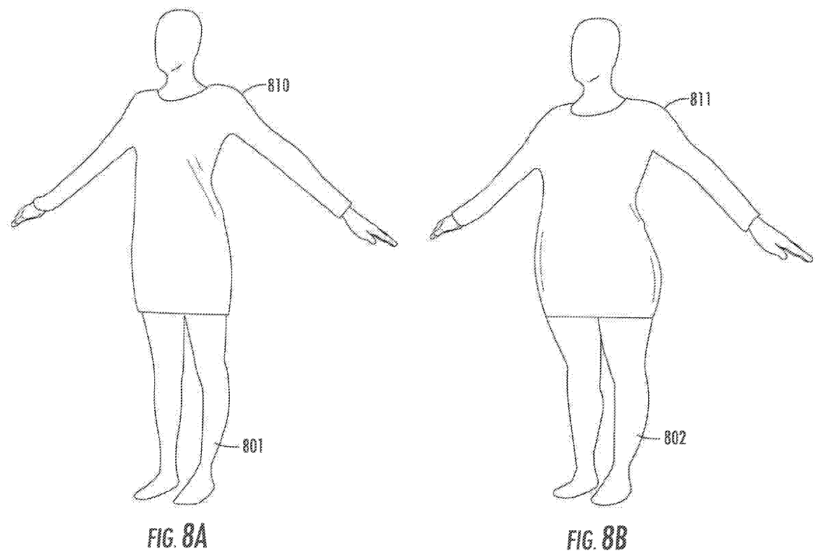

FIGS. 8(a) and 8(b) depict an example graphical diagram of a body-morphing approach to visualize garment deformation, according to example embodiments of the present disclosure. FIG. 8(a) depicts a template body model 801 that represents a template body inside a garment model 810. The template body model 801 is morphed into a target body while inside the garment model 810 using the finite element solver 150. FIG. 8(b) depicts a morphed body model 802 and a deformed garment model 811.

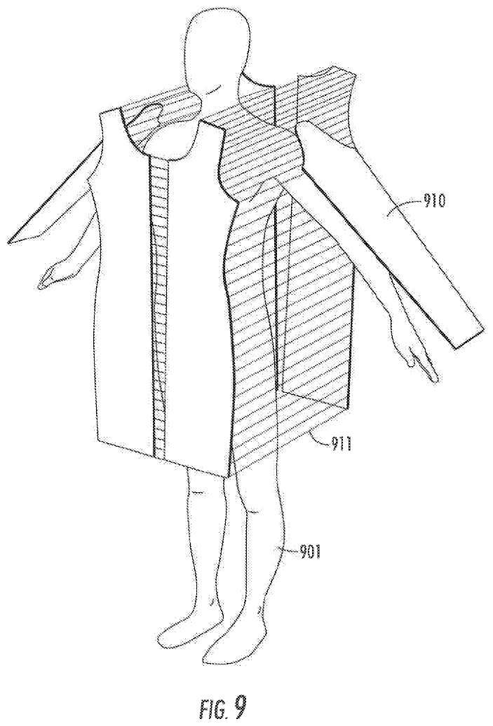

FIG. 9 depicts an example graphical diagram of preparing a garment model using a garment-stitching approach, according to example embodiments of the present disclosure. The garment panels 910 can be obtained, for example, by the garment pre-processor 140 from memory 120. The garment pre-processor 140 can classify the garment panels 910 according to body landmarks. In particular, the garment panels 910 can be classified according to the body landmarks: left arm, right arm, front left side torso, front right side torso, back left side, and back right side. The garment pre-processor 140 can position the garment panels 910 by matching the garment panels with the one or more predetermined body landmarks associated with the body model 901, based on the classification of the garment panels 910. The garment pre-processor 140 can determine a stitching sequence 911, and perform stitching by connecting the garment panels 910 according to the stitching sequence 911 in 3D. The garment pre-processor 140 can perform the stitching of the garment with or without the body model 901 between garment panels.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

Furthermore, computing tasks discussed herein as being performed at a computing device 101 can instead be performed at one or more computing devices remote from the computing device 101 (e.g., computing device(s) 102).

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for visualizing garment fit, the method comprising:
obtaining, by one or more computing devices, garment data descriptive of a garment and body data descriptive of a body;
simulating, by the one or more computing devices, a garment deformation of the garment due to contact from the body;
simulating, by the one or more computing devices, a body deformation of the body due to contact from the garment; and
providing, by the one or more computing devices, a visualization of the garment on the body for display to a user, the visualization visualizing the garment deformation and the body deformation.

2. The computer-implemented method of claim 1, further comprising:
preparing, by the one or more computing devices, a garment model of the garment by stitching one or more garment panels along one or more stitch lines or curves; and
preparing, by the one or more computing devices, a body model of the body by discretizing a representation of the body.

3. The computer-implemented method of claim 2, wherein simulating, by the one or more computing devices, the garment deformation of the garment comprises:
expanding, by the one or more computing devices, a spatially compressed representation of the body model to its original size inside the garment model; and
simulating, by the one or more computing devices, a deformation of the garment model using a modified finite element solver.

4. The computer-implemented method of claim 2, wherein:
preparing, by the one or more computing devices, the body model of the body comprises discretizing, by the one or more computing devices, a representation of a template body to form a template body model; and
simulating, by the one or more computing devices, the garment deformation of the garment on the body comprises:
morphing, by the one or more computing devices, the template body model to a target body model inside the garment model; and
simulating, by the one or more computing devices, a deformation of the garment model using a modified finite element solver.

5. The computer-implemented method of claim 2, wherein:
preparing, by the one or more computing devices, the garment model comprises stitching, by the one or more computing device, the one or more garment panels directly on the body model; and
simulating, by the one or more computing devices, the garment deformation of the garment on the body comprises simulating, by the one or more computing devices, a deformation of the garment model using a modified finite element solver.

6. The computer-implemented method of claim 2, wherein simulating, by the one or more computing devices, the body deformation of the body due to the garment comprises:
determining, by the one or more computing devices, a garment pressure on the body model; and
using, by the one or more computing devices, a soft-body dynamics solver to simulate a deformation of the body model based at least in part on the garment pressure.

7. The computer-implemented method of claim 2, wherein:
simulating, by the one or more computing devices, the deformation of the garment model is based one or more textile mechanical properties of the garment model.

8. The computer-implemented method of claim 2, wherein preparing, by the one or more computing devices, the body model comprises:
discretizing, by the one or more computing devices, the representation of the body into particles to create a particle-based body model.

9. The computer-implemented method of claim 2, wherein preparing, by the one or more computing devices, the body model comprises:
discretizing, by the one or more computing devices, the representation of the body into a surface mesh to create a mesh-based body model.

10. The computer-implemented method of claim 2, wherein preparing, by the one or more computing devices, the body model comprises:
discretizing, by the one or more computing devices, the representation of the body into a multi-layered tetrahedron mesh to create a volume-based body model, each layer corresponding to one or more body materials and having a thickness corresponding to a distribution of the one or more body materials in the body.

11. A computing device for simulating a fit and appearance of a garment on a body, comprising:
a modified finite element solver configured to simulate deformation of the garment on the body; and
a soft-body dynamics solver configured to simulate deformation of the body due to the garment.

12. The computing device of claim 11, further comprising:
a garment preprocessor configured to prepare a garment model of the garment by stitching one or more garment panels along one or more stitch lines or curves; and
a body preprocessor configured to prepare a body model of the body by discretizing a representation of the body.

13. The computing device of claim 12, wherein to simulate the deformation of the garment on the body, the finite element solver:
expands a spatially compressed representation of the body model to its original size inside the garment model.

14. The computing device of claim 12, wherein:
to prepare the body model, the body preprocessor prepares a template body model by discretizing a representation of a template body; and
to simulate the deformation of the garment on the body, the finite element solver morphs the template body model to a target body model inside the garment model.

15. The computing device of claim 12, wherein to prepare the garment model, the garment preprocessor:
stitches the one or more garment panels directly on the body model.

16. The computing device of claim 12, wherein to simulate the deformation of the body due to the garment, the soft-body dynamics solver:
determines a garment pressure on the body model.

17. The computing device of claim 12, further comprising:
a memory that stores one or more textile mechanical properties of the garment model, wherein simulating the deformation of the garment model is based on the one or more textile mechanical properties of the garment model.

18. The computing device of claim 12, wherein to prepare the body model the body preprocessor:
discretizes the representation of the body into particles to create a particle-based body model.

19. The computing device of claim 12, wherein to prepare the body model the body preprocessor:
discretizes the representation of the body into a surface mesh to create a mesh-based body model.

20. The computing device of claim 12, wherein to prepare the body model the body preprocessor:
discretizes the representation of the body model into a multi-layered tetrahedron mesh to create a volume-based body model, each layer corresponding to one or more body materials and having a thickness corresponding to a distribution of the one or more body materials in the body.

21. One or more tangible, non-transitory computer-readable media that collectively store instructions that, when executed by one or more computing devices, cause a computing system to perform operations, the operations comprising:
obtaining a garment model that models a garment and a body model that models a body;
using a finite element solver to simulate deformation of the garment due to contact with the body model according to at least one of a body expansion approach, a body morphing approach, and a garment stitching approach;
providing a visualization of the deformation of the garment model due to contact with the body model for display to a user.

22. The one or more tangible, non-transitory computer-readable media of claim 21, wherein:
using the finite element solver comprises using the finite element solver to simulate the deformation according to the body expansion approach; and
the body expansion approach comprises spatially compressing the body model toward a skeleton model that models a skeleton of the body.

23. The one or more tangible, non-transitory computer-readable media of claim 21, wherein:
using the finite element solver comprises using the finite element solver to simulate the deformation according to the body expansion approach; and
the body expansion approach comprises using ray casting to expand a compressed version of the body model to its original size.

24. The one or more tangible, non-transitory computer-readable media of claim 21, wherein:
using the finite element solver comprises using the finite element solver to simulate the deformation according to the body morphing approach; and
the body morphing approach comprises morphing a template body model that represents a template body to a target body model that represents a specific body.

25. The one or more tangible, non-transitory computer-readable media of claim 21, wherein:
using the finite element solver comprises using the finite element solver to simulate the deformation according to the garment stitching approach; and
the garment stitching approach comprises stitching the garment model directly on the body model.

27. The one or more tangible, non-transitory computer-readable media of claim 21, wherein the operations further comprise using a soft-body solver to simulate a deformation of the body model due to contact with the garment model, and wherein the visualization includes the deformation of the body model due to contact with the garment model.

28. A computer-implemented method for preparing a garment model, the method comprising:
obtaining, by one or more computing devices, garment data indicative of a first garment;
identifying, by the one or more computing devices, one or more garment panels of the first garment based at least in part on the garment data;
classifying, by the one or more computing devices, each of the one or more garment panels; and
preparing, by the one or more computing devices, a garment model for the first garment based at least in part on the identified one or more garment panels.

29. The computer-implemented method of claim 28, further comprising:
obtaining, by the one or more computing devices, a computer-aided design file including the garment data indicative of the first garment; and
identifying, by the one or more computing devices, the one or more garment panels of the first garment based at least in part on one or more garment panels included in the computer-aided design file.

30. The computer-implemented method of claim 28, further comprising:
estimating, by the one or more computing devices, a position of the one or more garment panels relative to a human body.

31. The computer-implemented method of claim 28, further comprising:
predicting, by the one or more computing devices, a stitching sequence to stitch the one or more garment panels.

32. The computer-implemented method of claim 28, further comprising:
identifying, by the one or more computing devices, one or more garment features in the one or more garment panels.

33. The computer-implemented method of claim 32, further comprising:
predicting, by the one or more computing devices, a stitching sequence of the one or more garment panels based at least in part on the one or more garment features.

34. The computer-implemented method of claim 32, wherein the one or more garment features include one or more of a dart, placket, pocket, or j-curve.

35. The computer-implemented method of claim 30, wherein estimating, by the one or more computing devices, the position of the one or more garment panels relative to a human body, comprises:
estimating, by the one or more computing devices, the position of the one or more garment panels based at least in part on a classification of the one or more garment panels.

36. The computer-implemented method of claim 30, further comprising:
identifying, by the one or more computing devices, one or more body landmarks corresponding to the one or more garment panels; and
positioning, by the one or more computing devices, the one or more garment panels based at least in part on the one or more body landmarks.

37. The computer-implemented method of claim 28, wherein preparing, by the one or more computing devices, the garment model comprises:
generating, by the one or more computing devices, a plurality of garment models that each correspond to a different garment size of the first garment.

38. The computer-implemented method of claim 28, wherein preparing, by the one or more computing devices, the garment model comprises:
generating, by the one or more computing devices, a first garment model that corresponds to the first garment; and
morphing, by the one or more computing devices, the first garment model to a second garment.

39. The computer-implemented method of claim 38, wherein the first garment model corresponds to a first size of the first garment, and the second garment model corresponds to a second size of the first garment.

40. The computer-implemented method of claim 38, wherein the second garment model corresponds to a second garment that is different than the first garment.

41. The computer-implemented method of claim 28, further comprising:
performing, by the one or more computing devices, virtual garment fitting based at least in part on the garment model.

42. The computer-implemented method of claim 28, further comprising:
inputting, by the one or more computing devices, the garment data into a machine learned model; and
obtaining, by the one or more computing devices, in response to inputting the garment data into the machine learned model, an output of the machine learned model that includes one or both of an identification of the one or more garment panels and a classification of the one or more garment panels.

43. A computing system for preparing a garment model, the system comprising:
one or more processors; and
one or more tangible, non-transitory, computer readable media that collectively store instructions that when executed by the one or more processors cause the computing system to perform operations, the operations comprising:
obtaining garment data indicative of a first garment;
identifying one or more garment panels of the first garment based at least in part on the garment data;
classifying each of the one or more garment panels; and
preparing a garment model for the first garment based at least in part on the identified one or more garment panels.
